(19) United States
(12) Patent Application Publication
(10) Pub. No.: US 2025/0069096 A1
(43) Pub. Date: Feb. 27, 2025

(54) VERIFYING SOURCE OF TEXT MESSAGE

(71) Applicant: SMARTCOM LABS OY, Helsinki (FI)

(72) Inventor: Robert BATZ, Vienna (AT)

(21) Appl. No.: 18/724,976

(22) PCT Filed: Dec. 29, 2022
(86) PCT No.: PCT/FI2022/050876

§ 371 Date: Jun. 27, 2024

(30) Foreign Application Priority Data
Dec. 31, 2021 (FI) 20216381

(51) Int. Cl. G06Q 30/018; H04L 9/40

(52) U.S. Cl. CPC G06Q 30/0185; H04L 63/126

(57) ABSTRACT

To verify at least a sender (source) of a text message, a verification data stored to a database is used. The verification data comprises at least a verification value, obtained by using at least an originating address and a destination address of the text message and a set of prime numbers. A first number is determined from the originating address, and converted, using the set of prime numbers to a first prime number. The destination address is processed in a similar way, resulting to a second prime number. The verification value is calculated by multiplying the first prime number and the second prime number.

### PRIORITY CLAIM AND RELATED APPLICATIONS

This patent application is a U.S. National Phase of International Patent Application No. PCT/FI2022/050876 filed Dec. 29, 2022, which claims priority to Finnish Patent Application No. 20216381, the disclosure of which being incorporated herein by reference in their entireties.

### TECHNICAL FIELD

Various example embodiments relate to text messages.

### BACKGROUND

Wireless communication systems are under constant development. With the development of information and communication technology, the applications of text messages have also increased quickly. At the same time also a fraudulent practice of sending text messages purporting to be from reputable companies in order to induce individuals to reveal personal information, such as passwords or credit card numbers, to a fraudulent sender, has increased. It is a challenging task to a recipient of a text message to determine, whether a text message sender is a fraudulent sender. Basically, when one wants to verify the source of the text message, one has to contact the enterprise that purportedly sent the message directly over the phone using the publicly available phone number rather than any number contained within the text message. It may be that one must then authenticate itself via credentials before one can speak to a representative of the company to verify the message. This is time-consuming and inconvenient for the customer who is suspicious of a received message, not to mention resources wasted in a legitime enterprise because of fraudulent actors in terms of internal call center resources dedicated towards fielding calls from customers.

### SUMMARY

An object of the disclosed embodiments is to provide a mechanism to verify a sender (source) of a text message. A general aspect of the disclosed embodiments uses at least an originating address, a destination address and a set of prime numbers to create a value usable for verifying a source.

### BRIEF DESCRIPTION OF DRAWINGS

Embodiments are described below, by way of example only, with reference to the accompanying drawings, in which

FIG. 1 illustrates an exemplified wireless communication system;

FIGS. 2 to 6 are flow charts illustrating example functionalities;

FIG. 7 illustrates an example of information exchange; and

FIG. 8 is a schematic block diagram.

### DETAILED DESCRIPTION

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned. Further, although terms including ordinal numbers, such as “first”, “second”, etc., may be used for describing various elements, the structural elements are not restricted by the terms. The terms are used merely for the purpose of distinguishing an element from other elements. For example, a first message could be termed a second message, and similarly, a second message could be also termed a first message without departing from the scope of the present disclosure.

Disclosed embodiments are applicable to any apparatus, system or equipment that is configured or configurable to support messaging services using text messages, or text form messages or any corresponding messages, comprising information indicating a source and information indicating a recipient. Such messaging services may be based on a short messaging service (SMS) technology, or be based on a proprietary technology, using for example a messaging application downloadable to an end user device, or using a messaging application provided as a part of operating system of the end user device. Different embodiments and examples are described below using single units, without restricting the embodiments/examples to such a solution. Concepts called cloud computing and virtualization may be used as well. The virtualization may allow a single physical computing device to host one or more instances of virtual machines that appear and operate as independent computing devices, so that a single physical computing device can create, maintain, delete, or otherwise manage virtual machines in a dynamic manner. It is also possible that device operations will be distributed among a plurality of servers, nodes, devices or hosts. In cloud computing network devices, computing devices and/or storage devices provide shared resources. Some other technology advancements, such as Software-Defined Networking (SDN), may cause one or more of the functionalities described below to be migrated to any corresponding abstraction or apparatus or device. Further, it should be appreciated that device and network capabilities, messaging techniques and implementing databases develop constantly. This may require some changes to the examples/embodiments that will be apparent to a person skilled in the art. Therefore, all words and expressions should be interpreted broadly, and they are intended to illustrate, not to restrict, the example or embodiment.

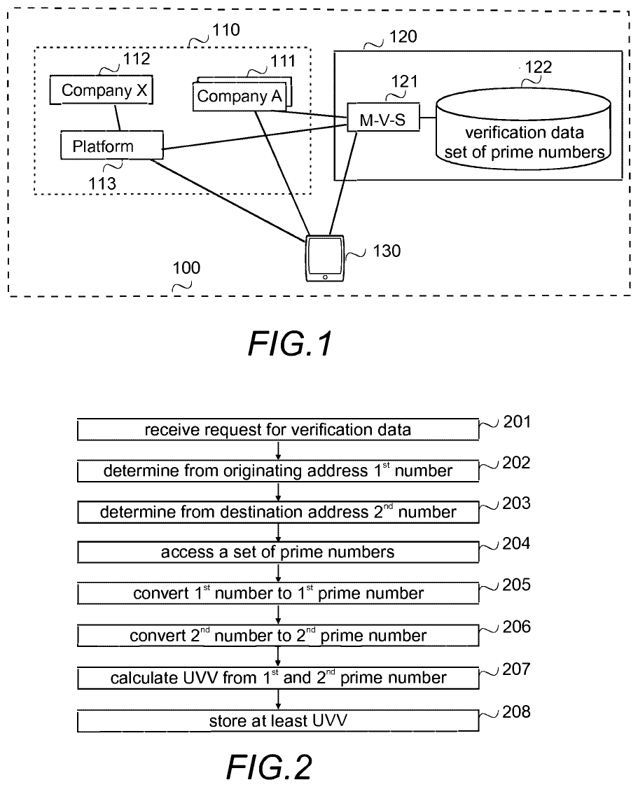

A general exemplary architecture of a system is illustrated in FIG. 1. FIG. 1 is a simplified system architecture only showing some devices, apparatuses, databases and functional entities, all being logical units whose implementation and/or number may differ from what is shown. The connections shown in FIG. 1 are logical connections; the actual physical connections may be different. It is apparent to a person skilled in the art that the system comprises any number of shown elements, other equipment, other functions and structures that are not illustrated. They, as well as networks and protocols used in messaging services, are well known by persons skilled in the art and are irrelevant to the actual inventive embodiments. Therefore, they need not to be discussed in more detail here.

In the embodiment illustrated in FIG. 1, the system 100 comprises a message source sub-domain 110, a common message source verification sub-domain 120 and a plurality of end user devices 130, only one being illustrated in FIG. 1.

The message source sub-domain 110 comprises different apparatuses 111, 112, 113 providing one or more messaging services, for example based on an application to person (A2P) messaging service. The application to person messaging service may be used by any type of an enterprise, company, or industry. A non-limiting list of examples include retail, banking, telecom, healthcare and travel, such as financial institutions, payment processors, government agencies, for example US Internal Revenue Service. Further, the application to person messaging service may be used for any type of application and/or for any purpose. A non-limiting list of examples include a mobile wallet, a cryptocurrency, a transaction verification, and an emergency alert. Hence, in the illustrated example of FIG. 1, the message source sub-domain 110 comprises enterprise, or company specific messaging service servers, or corresponding apparatuses, 111, 112 configured to either directly or via a platform 113 to send text messages to end user devices 130. Further, in the illustrated example of FIG. 1, the platform 113 and the apparatuses 111 that are configured to directly send text messages are further configured to send requests to a message verification server 121 in the common message source verification sub-domain 120. Depending on an implementation, the requests may be sent per a text message sent, or per a text message originating from a specific company and/or from a specific application.

The platform 113 may be a short messaging service platform, for example a third-party short message service messaging platform, or a communications platform-as-a-service (CPaaS) platform provided by a CPaaS provider, or a multi-channel messaging platform.

Below term “client” is used to cover apparatuses in the message source domain. Further, terms “sender”, “source” and “originator” are used herein as synonyms. Also verbs “sending” and “transmitting” are used herein as synonyms.

In the illustrated example of FIG. 1, the common message source verification sub-domain 120 comprises an apparatus 121, for example a server, providing message verifying services (M_V_S), as will be described in more detail below, and a database 122 comprising at least verification data and a set of prime numbers. In the illustrated examples it is assumed that message verifying services comprise both generating and storing the verification data and verifying at least a source of a text message. However, in another implementation they may be implemented as separate services. Further, the services may be implemented client and/or application-specifically. In other words, one or more of the clients in the message source sub-domain may be configured to provide message verifying services, or a service including generating and storing the verification data. The message verifying services may be provided by a third party provider, separately from messaging services, or with the messaging services (in which case sub-domains 110 and 120 are the same sub-domain). The third party provider can mediate the verification process across a wide number of enterprise users and end customers, such as CPaaS providers, payment joint venture organizations, and end user device operation system (mobile phone OS) providers.

The verification data may contain a plurality of records. Depending on an implementation, the verification data may comprise records comprising verification values, or records comprising verification values with additional data, or the verification data may comprise both kind of records. The verification value, or the verification value with additional data, may be called a “verified sender token”. Different examples how to obtain a verification value are discussed below. The additional data may comprise additional criteria, which be used for authentication purposes, for example a timestamp to authenticate a time of sending or creating a message to some level of precision. The additional data may include a one time code, for example a short pin code or a passcode, inserted into a body of a text message and transmitted within the message body of the text message as a distinct piece of data for verification. Such an implementation would adequately protect against smishing because a third party would not be able to know or guess a code applied from a particular sender to a particular recipient at a particular time. The additional data may comprise a hash, a check-sum or a fingerprint, calculated from a message body text, to protect against a man-in-the middle (MITM) attack. Further, the additional data may comprise more than one piece of data, for example the additional data may comprise a timestamp and a pin code. Naturally, any other kind of additional data may be used.

For example, in one potential scenario, a real bank and a fraudster could both send messages to a customer, or more precisely, to customer's end user device, asking the customer to call them. The customer would not easily know which was the authentic phone number to call. In this instance, it would not be enough to verify the sender address of the bank, and perhaps not even the timestamp, which may be similar between the two messages. A pin inserted into the message body could be used to further differentiate the real message (from the real bank) from the fraudulent message.

In the case of a sophisticated state-funded attack on the bank, the fraudster could attempt to use an SS7 attack to reroute SMS message traffic to a destination controlled by the attacker. The attacker could then alter the message content to their own benefit and send the modified (corrupted) message to the customer. In such an instance, an additional checksum-value derived from the original message text could foil this type of sophisticated attack. Hence, for some implementations, a checksum could be submitted in verification related requests as an additional piece of verification data with the purpose of verifying the integrity of the message contents, thus ensuring the content of the message has not been altered in some way by the attacker.

Optionally, a transaction value in a text message is not derivable from any data stored on the database, for example, it may not be stored as an additional piece of verification data because it puts sensitive private information at risk. However, there may be use cases where this is desired. In such cases, a transaction value (for example, a dollar amount), or an integer representing the transaction value, is included as a piece of additional data (additional verification data).

In the illustrated example, the database 122 comprises a set of prime numbers. However, it should be appreciated that there may be more than one set of prime numbers, for example client-specific for some clients, or shared by some clients, and/or application-specific or shared by some applications. The set of prime numbers are in the database 122, optionally, in a sorted order. It should be appreciated that any other order may be used as well, as long as the order is trackable when verification is needed. Depending on an implementation, the set of prime numbers may begin with the number 1, i.e., include the number 1, or may begin with the number 2, i.e., include the number 2, or the set of prime numbers, in a sorted order, may begin with a larger prime number, for example with the number 133, or with the number 21577, just to provide couple of examples. As is known, prime numbers are special numbers, that have exactly two factors, themselves and 1, and the number of prime numbers is infinite. Hence, there are no limitations to the size of the set of prime numbers, and the set of prime numbers may comprise prime numbers filtered by using any known mathematical or computational process. The filtering may reduce the size of the set of prime numbers. The size may be reduced for example by any definition, like “begin the set with nth prime number, and include in the set altogether N prime numbers”, or “include in the set every xth prime number up to zth prime number”.

The database 122 may be any kind of conventional or future data repository, including distributed and centralized storing of data, managed by any suitable management system. The database 122 may be publicly accessible database, or the database may be an external access limited database operated and accessed by a trusted party, for example by a trusted business partner or enterprise, and/or the database may be a shared database with limited access. For example, the database may be accessed only by, or via, the apparatuses 121 providing message verifying services. An example of distributed storing includes a cloud-based storage in a cloud environment (which may be a public cloud, a community cloud, a private cloud, or a hybrid cloud, for example). Cloud storage services may be accessed through a co-located cloud computer service, a web service application programming interface (API) or by applications that utilize API, such as cloud desktop storage, a cloud storage gateway or Web-based content management systems. Further, the common message source verification sub-domain 120 may comprise several apparatuses (servers) with databases, which may be integrated to be visible to clients as one database and one server. However, the implementation of the data storage, the manner how data is stored, retrieved and updated, and the location where different pieces of data are stored are irrelevant to the invention. In other words, any type of relational database, for example, whether public or private, can be used. Moreover, it is not essential whether or not the database and/or the message verifying service is operated internally within a company firewall, or external database and/or service shared by multiple enterprises, or whether the database is hosted and/or the service provided by a third party such as a telecom operator or CPaaS provider.

The end user device 130 may be any apparatus, computing device or user equipment configured to receive text messages and display/output them to a user via one or more user interfaces. A non-limiting list of examples of the end user device 130 include a personal computer, a mobile phone, a smartphone, a personal digital assistant (PDA), a laptop and/or a touch screen computer, a tablet (tablet computer), a multimedia device, a vehicle information system, a wearable computer and other types of wearable devices, such as clothing and accessories incorporating computer and advanced electronic technologies. The one or more user interfaces may be any kind of user interfaces, for example a screen, a keypad, a loudspeaker, a microphone, a touch user interface, an integrated display device, and/or an external display device.

For messaging services the end user device 130, called herein a mobile device, may comprise one or more messaging applications, for example a native messaging application and one or more third party messaging applications that may receive and send text messages and related information, including information exchange with the message verifying service(s) either in co-operation with a separate application or within the messaging application, via an operation system in the end user device, called herein a mobile operation system, or directly (i.e., by bypassing the operation system). Having the common or shared verifying service disclosed in FIG. 1 enables to use in the end user device a common smartphone app that would work with a large consortium of enterprise customers to verify them as legitime sources of text messages.

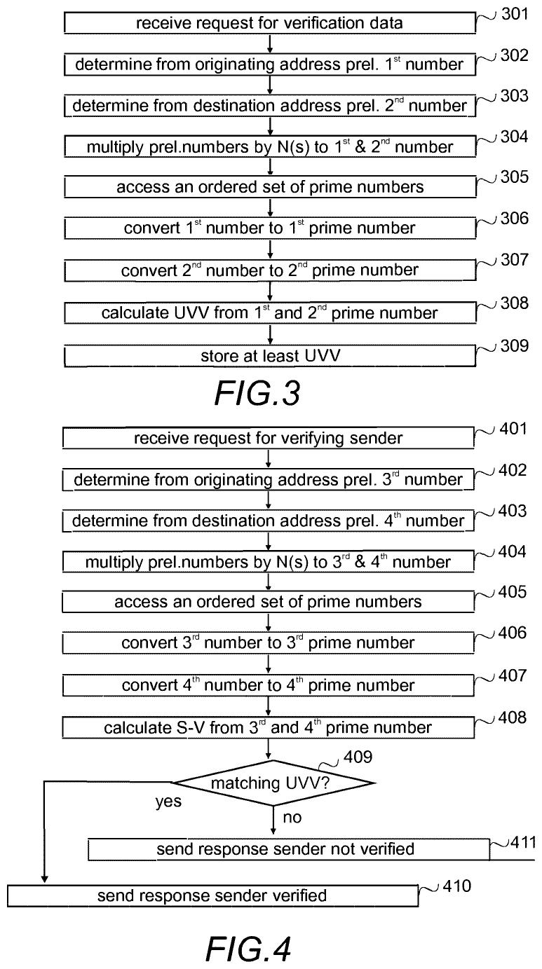

FIGS. 2 and 3 disclose different example functionalities how to create verification data.

Referring to FIG. 2, the process starts upon receiving (step 201) a first request for verification data for a text message, the request containing at least an originating address and a destination address of the text message. The request may be received over a network connection or may be internal request within an apparatus sending the text message and creating its verification data. The request may also contain additional data, non-limiting examples of which being discussed above. In an implementation, the request may contain the message body, and the process then includes calculating a hash, or a checksum, or a fingerprint from the message body.

A first number is determined (step 202) from the originating address and a second number (step 203) is determined from the destination address. The first and second number are optionally integers that are usable as ordinal numbers. The originating address may be alphanumerical sender identifier (sender address) or an all-numeric address, and the destination address (receiver address, recipient address) usually is an all-numeric address, for example a phone number, but can be an alphanumerical address (receiver identifier, recipient identifier). If the address is an alphanumerical address, in the determining step the address is first converted to a unique numeric sequence, for example by converting each alphabetical-letter in the alphanumeric address into a two-digit number 01 through 26 to obtain a string of numbers. If the address is an all-numerical address, for example a phone number 111-222-3456, in the determining step the address is converted to be an integer 1112223456.

Then a set of prime numbers is accessed (step 204), and the first number is converted (step 205) to a first prime number using the set of prime numbers and the second number is converted (step 206) to a second prime number using the set of prime numbers. When the set of prime numbers is an ordered set of prime numbers, conversions may include to use the first and second numbers as ordinal numbers x and y, and to select from the set of prime numbers xth and yth prime number. For example, if the first number is 22222, it is converted to be the 22222th prime number, which is 252233, and if the second number is 1112223456, it is converted to be the 1112223456th prime number, which is 25484729687.

Then a verification value, a unique verification value (UVV), is calculated (step 207) by multiplying the first prime number and the second prime number, and at least the verification value is stored (step 208) as the verification data to the verification database. Naturally, if additional data is to be stored with the verification value, it will also be stored.

FIG. 3 disclose another way to determine the verification value. The process disclosed in FIG. 3 is especially suitable when a shared or common database is used, to ensure that the first number (or the second number) that is based on an alphanumeric address does not overlap with a range of values for any purely numeric address (numbers determined from all-numeric addresses). For example, if the alphanumeric originator address is ‘XBank’ it may undergo a first conversion from an alphanumeric sending number to the number 2402011411, whereby each letter of the alphabet is translated to a two digit number corresponding to its place in the alphabet. However, in such a case, there is a risk that the numeric could also represent a separate number belonging to another party 240-201-1411. The easiest manner of preventing such collisions (duplicates) is to establish distinct sets (i.e., distinct ranges) to distinguish from pure numeric originator addresses and alphanumerics, and to accomplish this by using, for example, different constants in the initial conversion from the originator address (or sender id) to the ordinal number.

Referring to FIG. 3, the process differs from the one described with FIG. 2 in that respect that instead of determining directly from the addresses in the received (step 301) request the numbers, a number determined (step 302) from the originating address is a preliminary first number, and in the illustrated example, a number determined (step 303) from the destination address is a preliminary second number. The preliminary numbers are multiplied (step 304), per a preliminary number by a predetermined number N. The predetermined number may have the same value for both preliminary numbers, or different values for different preliminary numbers may be used, for example based on the type of address. When the value of the first number and the second number have been determined, the process continues as described above with FIG. 2. In other words, steps 305 to 309 corresponds to steps 204 to 208.

The predetermined number N may be, or be based on, a large constant, or a large constant for the originating address and a small constant for the destination address. For example, from a five digit SMS short code address 11111 a preliminary number 11111 may be determined, which is then multiplied by a constant 10\hat{ }6. This in turn identifies the 11111000000th prime number which is 281,326,994,251. In another example, the alphanumeric sender id “BankX” could be first converted to the numeric 25684 then multiplied by 10\hat{ }11 to define the nth prime number, whereas the pure numeric number 22659 short code originator number could be multiplied by 10\hat{ }17 to define the nth prime number. As can be seen, care must be taken to ensure that the constants are set such that there is zero possibility for overlap or number collision, which any ordinarily skilled mathematician, engineer, or programmer will find a trivial challenge.

In one implementation, the process may include checking, per an address received in the request, whether the address is an alphanumeric address, and if yes, perform step 302 or 303 and step 304, otherwise perform step 202 or 203, and then continue the process with the first number and the second number.

In other words, above examples describing how to determine the verification value encode the combined information of originating address (sender identifier) and destination address (receiver identifier) uniquely without any possible collisions with other address pairs. In other words, it would be mathematically impossible for alternative address pair inputs to reproduce the same output as another pair. This mathematical impossibility rests on the design of the algorithm to exploit the fundamental theorem of arithmetic, which states that every positive integer (except the number 1) can be represented in exactly one way apart from rearrangement as a product of one or more primes. This theorem is also called the unique factorization theorem.

Each verification value, no matter how large or small, performs identically in that it provides a unique, collision-free, error-free association to the addresses and any other inputs from which it was calculated. This achieves the main objective of providing a single unique value that can be used to verify the sender of the message without storing sensitive private data or any message contents whatsoever.

Further, the examples provide a built-in cryptographic mechanism, and the larger the prime numbers used to calculate the verification value, the greater the cryptographic strength. For example, the ordered set of prime numbers may comprise prime numbers with values greater than one million. In this example, n=1, which is the 1st prime number of the set, is the integer 1000003; and n=2 is the second prime number of the set, the integer 1000033. The advantage of starting the ordered set with a larger prime number is that the larger the two prime numbers being multiplied, the more computationally expensive it becomes to factor and decrypt a verification value to derive original address pair which produced it. However, even a set which begins with the prime number 1 or 2, preserves the far more essential quality of uniqueness, which is leveraged for error-free, collision-free source (message sender) verification.

At the simplest, the verification value may be used to verify a non-fraudulent source, by determining a search value using the same principles that are used to determine verification values, and trying to find from the database a matching verification value. If there is a match, the source (sender) is a non-fraudulent. In a more detailed example, a recipient receiving a text message may use, for example, a smartphone application to securely send addresses and possibly also additional data, potentially in encrypted form, to a remote server that would then transform the originating address and the destination address in the text message into prime numbers, multiply those two prime numbers to calculate a product, and then perform a database check to verify that the calculated product exactly matches to a record (entry) in the database. If the values match exactly, then the received message is legitimate, otherwise the received message is fraudulent. If additional data is part of the verification data, then also additional data should match exactly, to verify that the received message content has not been tampered.

FIG. 4 illustrates an example process how to use verification values to verify a source. It is straightforward to apply the process when also additional data is stored to be part of the verification data. In the example of FIG. 4, it is assumed that the principles described with FIG. 3 are used for verification values.

Referring to FIG. 4, the process starts upon receiving (step 401) a request for verifying a sender (source) of a text message, the request containing at least at least an originating address and a destination address of the text message. The request may also contain additional data, non-limiting examples of which being discussed above. In an implementation, the request may contain the message body, and the process then includes calculating a hash, or a checksum, or a fingerprint from the message body.

A preliminary third number is determined (step 402) from the originating address and a preliminary fourth number (step 403) is determined from the destination address. The preliminary numbers are multiplied (step 404), per a preliminary number by a predetermined number N to obtain a third number and a fourth number. The third number corresponds to the first number and the fourth number corresponds to the second number, and any of the above described examples to determine the numbers may be used.

Then the set of prime numbers is accessed (step 405), and the third number is converted (step 406) to a third prime number using the set of prime numbers and the fourth number is converted (step 407) to a fourth prime number using the set of prime numbers, correspondingly as with steps 205 and 206.

Then a search value (S-V) is calculated (step 408) by multiplying the third prime number and the fourth prime number. Then the database comprising verification data is accessed to find out, whether a matching verification value (UVV) can be found. If there is a verification value that is the same as the search value (step 409: yes), a response indicating that the sender is verified is sent (step 410). If there is no verification value that is the same as the search value (step 409: no), a response indicating that the sender is not verified is sent (step 411).

In other words, at least the end user terminal of the original message recipient is notified whether the verification has succeeded or failed.

In an implementation, in which the additional data is used, if a record having the same verification value than the search value, but different additional data is found, a response may indicate that the sender is verified but the message content is not verified.

To further illustrate, let's consider a first specific fraud scenario in which a fraudster sends a message in which they precisely imitate the formatting of a message commonly used by the enterprise application, but using either a faked sender address or a real sending address under their own control. In this case the originating number would be converted to an integer representing an ordinal number, and that ordinal number would correspond to a prime number that would be different from the value derived from the authentic sender address. This in turn would result in a false mathematical product being calculated for the search value, which would then be detected as false and therefore fraudulent during the verification stage.

In a second scenario, let's assume a fraudster sends an SMS in which they have spoofed (faked) the actual originating address belonging to the enterprise. In this case there would be no record in the database of the transaction and the smishing attempt would be detected.

FIG. 5 illustrates an example functionality of a legitime sender, or a platform used by the legitime sender. Depending on an implementation, the functionality may be performed per a text message transmitted (sent), or if a predetermined criterium or criteria is fulfilled. For example, the functionality may be performed whenever a message body includes a phone number, or whenever the message body includes a unified resource locator, or corresponding web address or link, or whenever the message body includes a currency symbol or an account number, and/or whenever the message is an application to person messaging service message and/or based on the purpose of the messaging application. Naturally any other criteria may be used.

Referring to FIG. 5, the process includes transmitting (step 501) a text message comprising an originating address, a destination address and message content (message body) towards the destination address; and sending (step 502) to a verification service a request for verification data for the text message, the request containing at least the originating address and the destination address of the text message. The transmitting and sending may be performed simultaneously.

The process of FIG. 5 may be triggered upon creating the text message or upon receiving the text message to be forwarded. In implementations, in which additional data is used, the process may include determining the additional data and adding it to the request before sending the request.

FIG. 6 illustrates an example functionality of an end user device. Depending on an implementation, the functionality may be performed per a text message received, or if a predetermined criterium or criteria is fulfilled, examples of which are given with FIG. 5. Further, the functionality may be performed automatically, i.e., without user involvement, or in response to providing a user a possibility to trigger the functionality, for example when the criterium or criteria is fulfilled.

Referring to FIG. 6, the process starts upon receiving (step 601), at a destination address, a text message comprising an originating address, the destination address and message content. In the illustrated example, it is assumed that a sender verification is performed when the predetermined criterium or criteria is fulfilled, or a user input requesting verification is received. Hence, in the illustrated example it is detected (step 602) that the criterium/criteria is fulfilled, or the user input received, and the sender verification should be performed. However, the step 602 may be omitted, if the functionality is performed per a text message received. Then a request for at least verifying the sender of the text message, the request containing at least the originating address and the destination address of the text message, is sent (step 603) to a verification service. Naturally in other implementations, also additional data may be sent to the verification service, or the message content may be sent to the verification service to extract the additional data from the message content. When a response indicating at least whether or not the sender is verified is received (step 604), the process continues (step 605) based on the indication and according to settings. For example, the message may be displayed to a user with additional information indicating “sender verified”, or “sender not verified”. According to another settings, when the request is sent without user involvement, the message may be indicated as received to a user only after a response indicating “sender verified” is received, otherwise the message may be deleted or hidden.

In another implementation, the process may contain a user receiving the text message in the end user device, and using a web portal, for example a website or a web application, to submit the request and display the response. For example, the web portal may allow the user to manually input at least both addresses, possibly also any other values.

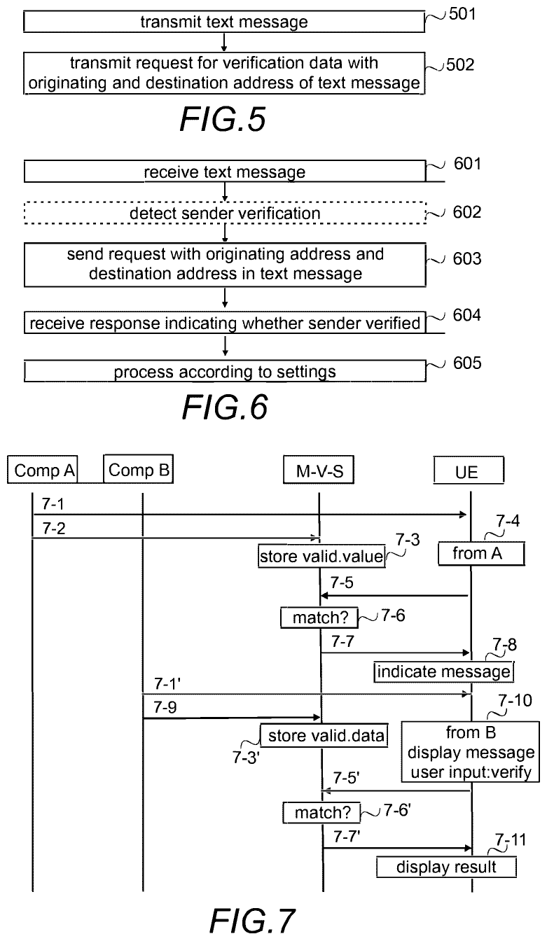

FIG. 7 illustrates an example of information exchange between different parties. In the example of FIG. 7 a shared verification service is used, a server M-V-S, for example a backend server, providing the service comprising the database against which database the check is made. Further, internal information exchange within apparatuses, including the server and the end user device, is not illustrated.

Referring to FIG. 7, an application to person messaging service server of a company A, Comp A, generates and transmits (message 7-1) a text message to a user (a customer) of the end user device, UE, and a request (message 7-2) for verification data of the text message to the server M-V-S. In the illustrated example, the application is an order confirmation application and the text message 7-1 confirms an order and comprises in the body at least a surname and an amount to be paid. Further, in the illustrated example, the server Comp A is configured to include to the request also the surname and the amount to be paid, due to the application being an order application.

Further, the server M-V-S is configured to calculate the verification value using also the surname and the amount to be paid (transaction value, or currency amount) in response to receiving from the server Comp A a request containing them. For example, the server M-V-S may convert all or part of the surname to be a prime number, using the principles described above, and the server M-V-S may convert all or part of the amount to be paid to be a prime number, and calculate the verification value by multiplying the prime numbers with the two prime numbers derived from the originating and destination addresses, and then store (step 7-3) the validation value to the database. For example, if the transaction value is 130 US dollars 45 cents, it may be converted to an ordinal number 130, and the 130th prime number is 733.

This is an example illustrating that also the message body, or part of it, may be converted to a prime number, and used in calculating the validation value. There is no need to store the surname in the database, thereby avoiding storing very private and sensitive data. Further, the transaction value is not derivable from any data stored on the database since it is not stored as an additional piece of verification data thereby not putting sensitive private information at risk. However, it should be appreciated the transaction value and/or the surname may be stored to the database as a piece of additional verification data.

The end user device is configured to automatically, without user involvements, when detecting (step 7-4) that the text message is from the Comp A, sends a request (message 7-5) to the server M-V-S for verifying the source and authenticating the content. The request may contain, for example encrypted, in addition to the originating address and the sender address, the message body (or the surname and the transaction amount).

Upon receiving the request (message 7-5), the server M-V-S calculates a search value using the principles disclosed above by deriving from the request the surname and the transaction value, converting all or part of the surname to be a prime number, and converting all or part of the amount to be paid to be a prime number, and calculate the search value by multiplying the prime numbers with the two prime numbers derived from the originating and destination addresses. Then the server M-V-S queries (step 7-6) the database to find out whether a match is found. In the illustrated example it is assumed that a match is found, and a corresponding notification (message 7-7) is sent to the end user device. Upon receiving a confirmation of a legitime source and non-tampered content, the end user device indicates (step 7-8) to the user that the text message (message 7-1) has been received, and the user can open the message and see the content.

Both ways of using the transaction value, with or without using the surname, prevents following fraud scenario: The enterprise may have sent a valid message to the recipient on the very same day as the smishing attempt. If the fraudster were to spoof the originating address to exactly match the authentic SMS sender number used by the enterprise, then during the verification stage, the fraud message would be converted to the correct prime number. The recipient destination address would also be converted to the correct prime number. And therefore the search value would also match the database, resulting in an error whereby a fraudulent message would be tagged as authentic.

Returning to FIG. 7, an application to person messaging service server of a company B, Comp B, generates and transmits (message 7-1′) a text message to the user of the end user device, UE, and a request (message 7-9) for verification data of the text message to the server M-V-S. In the illustrated example, the application is an advertising application and the text message 7-1 contains price information and product information. Hence, the server Comp B is configured to calculate a checksum from the message content and include to the request also the checksum, due to the message containing price information.

The server M-V-S is configured to calculate a verification value using the originating and destination address information and to store (step 7-3′) as validation data the verification value and the checksum in response to receiving from the server Comp B a request containing the checksum.

The end user device is configured, when detecting (step 7-10) that the text message is from the Comp B, indicate the message and display (step 7-10) the content of the message to the user. Further, the end user device is configured to provide the user a possibility to verify sender and content due to the text message being from the Comp B. In the illustrated example, a user input to perform the verification is received (step 7-10). For example, the user may have clicked “verify sender and content” icon. Hence, in the illustrated example, the end user device is configured to take a screenshot of the text message, and use the screenshot to calculate a checksum from the message content received. Then the end user device UE sends a request (message 7-5′) to the server M-V-S for verifying the source and authenticating the content. The request contains, for example encrypted, in addition to the originating address and the sender address, the checksum calculated. (Instead of calculating the checksum, message content could be included to the request).

Upon receiving the request (message 7-5′), the server M-V-S calculates a search value using the two prime numbers derived from the originating and destination addresses. Then the server M-V-S queries (step 7-6′) the database, using both the search value and the checksum receiving in message 7-5′ to find out whether a match is found and a notification (message 7-7′) indicating the result is sent to the end user device, which displays (step 7-11) the result to the user. In the illustrated example it is assumed that a match is found, the result displayed indicates a confirmation of a legitime source and non-tampered content.

Messages 7-1 and 7-1′ are two distinct messages sent to a customer from two distinct companies. Messages 7-2 and 7-9 are associated to messages 7-1, 7-1′, correspondingly, but entirely distinct from messages 7-1, 7-1′.

In the example of FIG. 7, an end user device, for example within a mobile operation system, is configured to both automatically perform the verification step and display the result to the user without the user needing to initiate it, and to provide the verification step in a post-hoc manner, where the user has a means to verify a text message after it has already been received and read. Another implementation within a mobile OS would build the verification directly into the native messaging app which handles SMS and/or other messaging types. This implementation would enable users a one-click method without having to leave the messaging app and without the user having to manually enter any data.

As can be seen from the above examples, means to perform the verification outside of a messaging service protocol and without modifying the messaging service protocol, nor modifying the telecom infrastructure upon which messages are transmitted, are disclosed.

As is evident from the above examples, an easy way for an application to provide sender verification either in real-time or post-hoc even where a large pool of numbers is used by a single enterprise or application. Because sender and receiver numbers are usually the common identifier spanning multiple messaging apps, the disclosed embodiments have a channel-agnostic aspect. A single implementation or protocol could provide sender verification that works on any messaging channel. In other words, the disclosed solutions can be used with legacy user devices, for example with a vast majority of mobile phones in circulation, as well as with most legacy operating systems, for example with most mobile operating systems in circulation, provides backwards compatibility with existing GSM standards for short message services, and sharing message content or private customer data with third party private-sector companies is avoided.

The above examples comply with strict data compliance requirements and would enable banks, other business enterprises, and government agencies to confirm/verify to customers the authenticity and integrity of messages without actually sharing that information. In other words, examples employ the concept of “target removal”, which is that you can't steal what isn't there in the first place. In one implementation, the only information entering such a system from the outside is a query as to the legitimacy of the message, and the only thing coming out of the system is a simple affirmation or rejection of the message authenticity and/or integrity. In the most extreme case to be considered, if a foreign state actor or other sophisticated third party were to gain access behind a bank's firewall, gain access to the database described here, and then somehow decrypt the data (somehow overcoming current mathematical limitations), then they would only gain access to very limited information that Phone Number A sent Phone number B a message at the time. No details of the transaction, nor content of messages sent/received would be stored (nor directly derivable) in relation to the solution described herein and so there is no high-stakes private data at risk.

The steps, related functions, and information exchanges described above by means of FIGS. 1 to 7 are in no absolute chronological order, and some of them may be performed simultaneously or in an order differing from the given one. Other functions can also be executed between them or within them, and other information may be sent, and/or other rules applied. Some of the steps or part of the steps or one or more pieces of information can also be left out or replaced by a corresponding step or part of the step or one or more pieces of information. For example, instead of maintaining the database by an entity performing the verification and value calculations, the database may be accessed by the entity and maintained by another entity. If the database is a shared database, one of entities may be configured to maintain and access the database, whereas the other entities may be configured to access the database.

The techniques described herein may be implemented by various means so that an apparatus/equipment implementing one or more functions/operations described above with an embodiment/example, for example by means of any of FIGS. 1 to 3 and any combination thereof, comprises not only prior art means, but also means for implementing the one or more functions/operations of a corresponding functionality described with an embodiment, for example by means of any of FIGS. 1 to 3 and any combination thereof, and it may comprise separate means for each separate function/operation, or means may be configured to perform two or more functions/operations. For example, one or more of the means, or any corresponding unit, for one or more functions/operations described above may be software and/or software-hardware and/or hardware and/or firmware components (recorded indelibly on a medium such as read-only-memory or embodied in hard-wired computer circuitry) or combinations thereof. Software codes may be stored in any suitable, processor/computer-readable data storage medium(s) or memory unit(s) or article(s) of manufacture and executed by one or more processors/computers, hardware (one or more apparatuses), firmware (one or more apparatuses), software (one or more modules), or combinations thereof, to configure the one or more apparatuses (equipment) to perform the specific technical task. For a firmware or software, implementation can be through modules (e.g., procedures, functions, and so on) that perform the functions described herein.

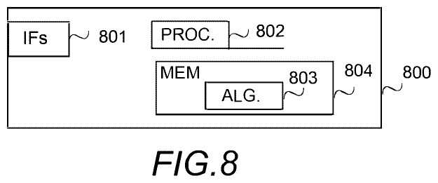

FIG. 8 is a simplified block diagram illustrating some units for an apparatus (device, equipment) 800 configured to perform at least some functionality described above, for example by means of any of FIGS. 1 to 7 and any combination thereof, or some of the functionalities if functionalities are distributed. The apparatus 800 may be an apparatus providing one or more messaging services and/or a platform for one or more messaging services and/or an apparatus providing messaging verifying services, configured to perform at least functionality described with FIG. 5 and/or with FIG. 2 and/or with FIG. 3, and/or with FIG. 4, and/or functionality described with an application to person messaging service server with FIG. 7 and/or with the server M-V-S with FIG. 7. The apparatus 800 may be an end user device or corresponding apparatus comprising one or more messaging applications, configured to perform at least functionality described with FIG. 6 and/or at least some of the functionality of the end user device. In a still further embodiment, the apparatus may be a combination of the end user terminal and an apparatus providing one or more messaging services and/or a platform for one or more messaging services, and/or an apparatus providing messaging verifying services, configured correspondingly.

In the illustrated example, the apparatus 800 comprises one or more interfaces (IF) 801, one or more processing entities 802 connected to various interfaces 801 and to one or more memories 804.

The one or more interfaces 801 are entities for receiving and transmitting information, such as communication interfaces comprising hardware and/or software for realizing communication connectivity according to one or more communication protocols, or for realizing data storing and fetching, for example to/from the data storage comprising verification information and/or set(s) of prime numbers, or for providing user interaction via one or more user interfaces. The one or more user interfaces may be any kind of a user interface, for example a screen, a keypad, or an integrated display device or external display device.

A processing entity 802 is capable to perform calculations and configured to implement at least part of functionalities/operations described above, for example by means of any of FIGS. 1 to 7 and any combination thereof, with corresponding algorithms 803 stored in the memory 804. The processing entity 802 may include one or more processors, controllers, control units, micro-controllers, etc. configurable to carry out embodiments and/or examples and/or implementations or operations described above, for example by means of any of FIGS. 1 to 7 and any combination thereof. Generally a processor is a central processing unit, but the processor may be an additional operation processor or a multicore processor or a microprocessor.

A memory 804 is usable for storing a computer program code required for one or more source verification functionalities, i.e., for one or more functionalities/operations described above, for example by means of any of FIGS. 1 to 7 and any combination thereof, i.e., the algorithms for implementing the functionality/operations described above by means of any of FIGS. 1 to 7 and any combination thereof. The memory 804 may also be usable for storing other possible information.

As a summary, source, and possibly content verification related functions/operations described herein relating to text message, for example by means of means of any of FIGS. 1 to 7 and any combination thereof, may be configured as a computer or a processor, or a microprocessor, such as a single-chip computer element, or as a chipset, or one or more logic gates including at least a memory for providing storage area used for arithmetic operation and an operation processor for executing the arithmetic operation. Each or some or one of the algorithms for functions/operations described above, for example by means of any of FIGS. 1 to 7 and any combination thereof, may comprise one or more computer processors, application-specific integrated circuits (ASIC), digital signal processors (DSP), digital signal processing devices (DSPD), programmable logic devices (PLD), field-programmable gate arrays (FPGA), graphics processing units (GPU) and/or other hardware components that have been programmed and/or will be programmed by downloading computer program code (one or more algorithms) in such a way to carry out one or more functions of one or more embodiments/examples.

An embodiment provides a computer program embodied on any client-readable distribution/data storage medium or memory unit(s) or article(s) of manufacture, comprising program instructions executable by one or more processors/computers, which instructions, when loaded into an apparatus (device, server, platform), constitute an entity providing corresponding functionality, or at least part of the corresponding functionality. Programs, also called program products, including software routines, program snippets constituting “program libraries”, applets and macros, can be stored in any medium, including non-transitory computer readable storage medium, and may be downloaded into an apparatus. In other words, each or some or one of the equipment and/or the algorithms for one or more functions/operations described above, for example by means of any of FIGS. 1 to 7 and any combination thereof, may be an element that comprises one or more arithmetic logic units, a number of special registers and control circuits.

Even though the disclosed embodiments has been described above with reference to examples according to the accompanying drawings, it is clear that the disclosed embodiments are not restricted thereto but can be modified in several ways within the scope of the appended claims. Therefore, all words and expressions should be interpreted broadly and they are intended to illustrate, not to restrict, the embodiment/example. It will be obvious to a person skilled in the art that, as technology advances, the inventive concept can be implemented in various ways. Further, it is clear to a person skilled in the art that the described examples may, but are not required to, be combined with other examples in various ways.

1. A computer implemented method comprising at least:
receiving a first request for verification data for a text message, the request containing at least an originating address and a destination address of the text message;
determining, from the originating address, a first number;
determining, from the destination address, a second number;
accessing a set of prime numbers;
converting the first number to a first prime number using the set of prime numbers;
converting the second number to a second prime number using the set of prime numbers;
calculating a verification value by multiplying the first prime number and the second prime number; and
storing at least the verification value as the verification data to a verification database.

2. A computer implemented method comprising at least:
receiving a second request to verify at least sender of a text message, the request containing at least an originating address and a destination address of the text message;
determining, from the originating address, a third number;
determining, from the destination address, a fourth number;
accessing an ordered set of prime numbers;
converting the third number to a third prime number using the ordered set of prime numbers;
converting the fourth number to a fourth prime number using the set of prime number;
calculating a search value by multiplying the third prime number and the fourth prime number;
searching a match at least to the search value in a verification data stored to a database;
sending, in response to finding at least a verification value matching to the search value, a response indicating that the text message sender is verified; and
sending, in response to not finding a match, a response indicating that the text message sender is not verified.

3. The computer implemented method of claim 2, further comprising:
storing to the verification data additional data associated with the verification value;
receiving in the second request one or more pieces of additional data;
searching a match to a combination of the search value and additional data in the verification data;
sending, in response to finding a match, a response indicating that the text message sender and text message content are verified; and
sending, in response to not finding a match, a response indicating that the text message sender or the text message content is not verified.

4. The computer implemented method of claim 2, further comprising:
receiving in a request at least one of name information of the text message recipient or numerical information;
converting at least one of the name information and/or the numerical information to corresponding one or more prime numbers; and
calculating the verification value or the search value by multiplying all converted prime numbers.

5. The computer implemented method of claim 2, further comprising, when determining a number from an address:
converting the address to an integer; and
obtaining the number by multiplying the integer with a predetermined number.

6.-18. (canceled)

19. The computer implemented method of claim 1, further comprising:
receiving in a request at least one of name information of the text message recipient or numerical information;
converting at least one of the name information or the numerical information to corresponding one or more prime numbers; and
calculating the verification value or the search value by multiplying all converted prime numbers.

20. The computer implemented method of claim 1, further comprising, when determining a number from an address:
converting the address to an integer; and
obtaining the number by multiplying the integer with a predetermined number.

21. An apparatus comprising:
at least one processor; and
at least one memory including computer program code and operable connected to the at least one processor; the at least one memory and the computer program code being configured to, with the at least one processor, to cause the apparatus at least to perform a first process or a second process,
wherein the first process comprises at least:
receiving a first request for verification data for a text message, the request containing at least an originating address and a destination address of the text message;
determining, from the originating address, a first number;
determining, from the destination address, a second number;
accessing a set of prime numbers;
converting the first number to a first prime number using the set of prime numbers;
converting the second number to a second prime number using the set of prime numbers;
calculating a verification value by multiplying the first prime number and the second prime number; and
storing at least the verification value as the verification data to a verification database;
wherein the second process comprises at least:
receiving a second request to verify at least sender of a text message, the request containing at least an originating address and a destination address of the text message;
determining, from the originating address, a third number;
determining, from the destination address, a fourth number;
accessing an ordered set of prime numbers;
converting the third number to a third prime number using the ordered set of prime numbers;
converting the fourth number to a fourth prime number using the set of prime number;
calculating a search value by multiplying the third prime number and the fourth prime number;
searching a match at least to the search value in a verification data stored to a database;
sending, in response to finding at least a verification value matching to the search value, a response indicating that the text message sender is verified; and
sending, in response to not finding a match, a response indicating that the text message sender is not verified.

22. The apparatus of claim 21, wherein the at least one memory and computer program code configured to, with the at least one processor, cause the apparatus further to at least to perform:
storing to the verification data additional data associated with the verification value;
receiving in the second request one or more pieces of additional data;
searching a match to a combination of the search value and additional data in the verification data;
sending, in response to finding a match, a response indicating that the text message sender and text message content are verified; and
sending, in response to not finding a match, a response indicating that the text message sender or the text message content is not verified

23. The apparatus of claim 21, wherein the at least one memory and computer program code are configured to, with the at least one processor, cause the apparatus to at least:
receive, in a request, at least one of name information of the text message recipient or numerical information;
convert at least one of the name information or the numerical information to corresponding one or more prime numbers; and
calculate the verification value or the search value by multiplying all converted prime numbers.

24. The apparatus of claim 21, wherein the at least one memory and computer program code configured to, with the at least one processor, cause the apparatus, when determining a number from an address, to at least:
convert the address to an integer; and
obtain the number by multiplying the integer with a predetermined number.

25. The apparatus of claim 21, wherein the apparatus is a server apparatus, and the at least one memory and computer program code configured to, with the at least one processor, cause the apparatus to at least receive the first request from a second apparatus, which transmitted the text message towards the destination address.

26. The apparatus of claim 21, wherein the apparatus is a server apparatus, and the at least one memory and computer program code configured to, with the at least one processor, cause the apparatus to receive the second request from a third apparatus, which received, at a destination address, the text message.

27. The apparatus of claim 26, wherein the second request is received in response to a user input to the second apparatus requesting verification.

28. The apparatus of claim 21, wherein the apparatus is a server apparatus, and the at least one memory and computer program code configured to, with the at least one processor, cause the apparatus further to at least perform the first process and the second process including:
receiving the first request from a second apparatus, which transmitted the text message towards the destination address; and
receiving the second request from a third apparatus, which received, at a destination address, the text message.

29. A non-transitory computer-readable medium comprising program instructions, which, when run by a computer, causes the computer to carry out at least a first process or a second process,
wherein the first process comprises at least:
determining, in response to receiving a first request for verification data for a text message, the request containing at least an originating address and a destination address of the text message, from the originating address, a first number;
determining, from the destination address, a second number;
accessing a set of prime numbers;
converting the first number to a first prime number using the set of prime numbers;
converting the second number to a second prime number using the set of prime numbers;
calculating a verification value by multiplying the first prime number and the second prime number; and
storing at least the verification value as the verification data to a verification database,
wherein the second process comprises at least:
determining, in response to receiving a second request to verify at least sender of a text message, the request containing at least an originating address and a destination address of the text message, from the originating address, a third number;
determining, from the destination address, a fourth number;
accessing an ordered set of prime numbers;
converting the third number to a third prime number using the ordered set of prime numbers;
converting the fourth number to a fourth prime number using the set of prime number;
calculating a search value by multiplying the third prime number and the fourth prime number;
searching a match at least to the search value in a verification data stored to a database;
sending, in response to finding at least a verification value matching to the search value, a response indicating that the text message sender is verified; and
sending, in response to not finding a match, a response indicating that the text message sender is not verified.

30. The non-transitory computer-readable medium of claim 29, comprising further program instructions, which, when run by a computer, cause the computer to at least:
store to the verification data additional data associated with the verification value;
receive in the second request one or more pieces of additional data;
search a match to a combination of the search value and additional data in the verification data;
send, in response to finding a match, a response indicating that the text message sender and text message content are verified; and
send, in response to not finding a match, a response indicating that the text message sender or the text message content is not verified.

31. The non-transitory computer-readable medium of claim 29, comprising further program instructions, which, when run by a computer, cause the computer to at least:
receive in a request at least one of name information of the text message recipient or numerical information;
convert at least one of the name information or the numerical information to corresponding one or more prime numbers; and
calculate the verification value or the search value by multiplying all converted prime numbers.

32. The non-transitory computer-readable medium of claim 29, comprising further program instructions, which, when run by a computer, cause the computer to at least:
convert the address to an integer; and
obtain the number by multiplying the integer with a predetermined number.
